(19) United States
(12) Patent Application Publication
(10) Pub. No.: US 2021/0319340 A1
(43) Pub. Date: Oct. 14, 2021

(54) MACHINE LEARNING MODEL CONFIDENCE SCORE VALIDATION

(71) Applicant: DATALOOP LTD., Herzliya (IL)

(72) Inventors: Or SHABTAY, Tel-Aviv (IL); Eran SHLOMO, Zichron Yaakov (IL)

(21) Appl. No.: 17/228,133

(22) Filed: Apr. 12, 2021

Related U.S. Application Data
(60) Provisional application No. 63/009,164, filed on Apr. 13, 2020.

(51) Int. Cl. G06N 5/04; G06N 20/00

(52) U.S. Cl. CPC G06N 5/04; G06N 20/00

(57) ABSTRACT

A method comprising: receiving, as input, an image for classification by a trained machine learning model, generate a data set comprising a plurality of transformations of the image; applying, to each of the transformations in the data set, the trained machine learning model, to obtain a classification with respect to the transformation, wherein the classification has an associated confidence score; computing (i) a consensus classification based on all of the obtained classifications with respect to each of the transformations, and (ii) a consensus confidence score corresponding to the consensus classification, based on all of the associated confidence scores; and outputting the consensus classification and the corresponding consensus confidence score, as a classification result with respect to the image.

### CROSS-REFERENCE TO RELATED APPLICATIONS

This application claims the benefit of priority U.S. Provisional Patent Application No. 63/009,164, filed Apr. 13, 2020, the content of which is incorporated by reference herein in its entirety.

### BACKGROUND OF THE INVENTION

The invention relates to the field of machine learning.

A variety of applications rely on classifying images based on their visual content. Fully automated machine learning-based systems are used, where image labels are automatically predicted without any user interaction. The image can then be classified to assign one or more labels corresponding to the most probable class(es) identified in the image.

Confidence scores are a way of quantifying the level of certainty that a classified object is indeed a member of the assigned class. Thus, when a classifier assigns a class label to a detected object in an image, it may indicate the level of confidence of the classifier in that prediction (e.g., 90%). However, when a classifier fails in the classification task, e.g., because a target data sample falls out of the distribution of training samples, the classifier may still output a high confidence prediction.

The foregoing examples of the related art and limitations related therewith are intended to be illustrative and not exclusive. Other limitations of the related art will become apparent to those of skill in the art upon a reading of the specification and a study of the figures.

### SUMMARY OF THE INVENTION

The following embodiments and aspects thereof are described and illustrated in conjunction with systems, tools and methods which are meant to be exemplary and illustrative, not limiting in scope.

There is provided, in an embodiment, a system comprising at least one hardware processor; and a non-transitory computer-readable storage medium having stored thereon program instructions, the program instructions executable by the at least one hardware processor to: receive, as input, an image for classification by a trained machine learning model, generate a data set comprising a plurality of transformations of the image, apply, to each of the transformations in the data set, the trained machine learning model, to obtain a classification with respect to the transformation, wherein the classification has an associated confidence score, compute: (i) a consensus classification based on all of the obtained classifications with respect to each of the transformations, and (ii) a consensus confidence score corresponding to the consensus classification, based on all of the associated confidence scores, and output the consensus classification and the corresponding consensus confidence score, as a classification result with respect to the image.

There is also provided, in an embodiment, a method comprising: receiving, as input, an image for classification by a trained machine learning model, generate a data set comprising a plurality of transformations of the image; applying, to each of the transformations in the data set, the trained machine learning model, to obtain a classification with respect to the transformation, wherein the classification has an associated confidence score; computing: (i) a consensus classification based on all of the obtained classifications with respect to each of the transformations, and (ii) a consensus confidence score corresponding to the consensus classification, based on all of the associated confidence scores; and outputting the consensus classification and the corresponding consensus confidence score, as a classification result with respect to the image.

There is further provided, in an embodiment, a computer program product comprising a non-transitory computer-readable storage medium having program instructions embodied therewith, the program instructions executable by at least one hardware processor to: receive, as input, an image for classification by a trained machine learning model; generate a data set comprising a plurality of transformations of the image; apply, to each of the transformations in the data set, the trained machine learning model, to obtain a classification with respect to the transformation, wherein the classification has an associated confidence score; compute: (i) a consensus classification based on all of the obtained classifications with respect to each of the transformations, and (ii) a consensus confidence score corresponding to the consensus classification, based on all of the associated confidence scores; and output the consensus classification and the corresponding consensus confidence score, as a classification result with respect to the image.

In some embodiments, the program instructions are further executable to assign, and the method further comprises assigning, (i) the consensus classification and (ii) the corresponding consensus confidence score, as annotations to at least one of the transformations in the data set, to obtain at least one annotated transformation.

In some embodiments, the program instructions are further executable to use, and the method further comprises using, the at least one annotated transformation to re-train the trained machine learning model.

In some embodiments, the classification comprises assigning the image to one of one or more categories.

In some embodiments, the classification comprises performing, with respect to each of the transformations, object detection with respect to an object of interest.

In some embodiments, with respect to each of the transformations, the object detection is represented as a bounding region enclosing the object of interest.

In some embodiments, the computing of the consensus classification comprises (i) translating each of the bounding regions to corresponding coordinates in the image, and (ii) computing a consensus bounding region from all of the translated bounding regions.

In some embodiments, the program instructions are further executable to assign, and the method further comprises assigning, (i) the consensus bounding region and (ii) the consensus confidence score, as annotations to at least one of the transformations in the data set, to obtain at least one annotated transformation.

In some embodiments, the program instructions are further executable to use, and the method further comprises using, the at least one annotated transformation to re-train the trained machine learning model.

In some embodiments, the computing of the consensus classification is based, at least in part, on a weighted sum calculation of all of the obtained classifications, and wherein the weights are based on the confidence scores associated with each of the obtained classifications.

In some embodiments, the transformations comprise one or more of: image enhancements, image contrast enhancements, image contrast stretching, image gray level thresholding, image color changes, image filtering, image Gaussian blur, image sharpening, image gamma correction, image shearing, image padding, image reflection, image warping, image scaling, image rotations, image translations, image flipping, affine image transformations, geometric image transformations, and image projections.

In addition to the exemplary aspects and embodiments described above, further aspects and embodiments will become apparent by reference to the figures and by study of the following detailed description.

### BRIEF DESCRIPTION OF THE FIGURES

Exemplary embodiments are illustrated in referenced figures. Dimensions of components and features shown in the figures are generally chosen for convenience and clarity of presentation and are not necessarily shown to scale. The figures are listed below.

FIG. 1 illustrates an exemplary system 100 for automated real-time confidence score validation, in accordance with some embodiments of the present invention;

FIG. 2 is a flowchart detailing the functional steps in a process for automated real-time confidence score validation, in accordance with some embodiments of the present invention;

FIGS. 3A-3C schematically illustrate a process for automated real-time confidence score validation in image classification, in accordance with some embodiments of the present invention; and

FIGS. 4A-4E schematically illustrate a process for automated real-time confidence score validation in object detection, in accordance with some embodiments of the present invention.

### DETAILED DESCRIPTION OF THE INVENTION

Disclosed herein is a technique, embodied in a system, method, and computer program product, for automated real-time validation of a confidence score associated with an inference instance of a trained machine learning model.

In some embodiments, the present disclosure provides for increasing the certainty of a confidence score assigned to an inference instance of a machine learning model over a target data sample. In some embodiments, the present disclosure may further provide for identifying target and/or test samples which do not produce positive inference results, which may further assist in re-training and refining the inference model.

As used herein, ‘machine learning model’ refers broadly to any of several methods and/or algorithms which are configured to perform a specific informational task (such as classification) using a limited number of examples of data of a given form, and are then capable of exercising this same task on unknown data of the same type and form. A machine learning model may be implemented using various model architectures and training algorithms.

Throughout this disclosure, ‘confidence score’ and ‘confidence interval’ may be used interchangeably to denote a value which represents a quantifying of an uncertainty of an inference instance produced by a trained machine learning model. In the context of a classification task, i.e., a task where a label or class outcome variable is predicted given some input data, a confidence score or interval is the probability or likelihood that a data sample belongs to the class to which is was assigned.

In some embodiments, the present disclosure provides for evaluating and/or validating a confidence score assigned by a trained machine learning model to a prediction and/or a classification with respect to a new (target) data sample, to determine an accuracy of the confidence score associated with the particular inference instance.

In some embodiments, confidence score validation according to the present disclosure is based, at least in part, on iterating the inference multiple times over a plurality of transformations of the target data sample, and combining the corresponding confidence scores assigned to the all the iterations, to obtain a consensus confidence score.

Accordingly, in some embodiments, a trained machine learning model is applied to a target data sample, e.g., an image or one or more segments thereof, to generate a prediction with respect to the data sample as a whole and/or one or more objects within the image. For example, the trained machine learning model may be an image classification model configured to predict what an image represents. In other examples, the model may be an object detection model configured to detect instances of semantic objects of a certain class (such as humans, buildings, or cars) in an image. In other examples, additional and/or other computer vision tasks may be employed, e.g., object recognition, object identification, pose estimation, optical character recognition, facial recognition, and the like.

In some embodiments, the machine learning model may further be configured to perform the classification task, to determine to which of a set of categories the data instance belongs, on the basis of a training set of data containing instances with known class membership. However, because uncertainty is an inherent part of the classification task, the inference results typically are associated with a confidence score representing the likelihood that a target data sample actually belongs to the class to which it is assigned by the classification model. Accordingly, the classification task can be interpreted as a classification problem that estimates probabilities of classes being present in the data instance.

For example, in the task of object detection, the goal is to map an image to a set of regions (e.g., one region per object of interest), each tightly enclosing an object. This means that object detectors ought to return exactly one detection per object. Because uncertainty is an inherent part of the detection process, evaluations allow detections to be associated with a confidence score. Accordingly, the detection problem can be interpreted as a classification problem that estimates probabilities of object classes being present for every possible detection in an image.

Accordingly, the classification task may comprise probabilistic classification, wherein a statistical inference finds the best class for a given instance, with a probability of the instance being a member of each of the possible classes. The best class, or the class associated with a probability above a specified threshold (e.g., 50% or 70%) may then be selected as the prediction output.

However, in some embodiments, an inference instance of a classification may by assigned a relatively high confidence score, when in reality, the classification is incorrect. This may happen, e.g., in cases where the training and target data sample distributions differ; where there was inadequate or insufficient training of the model; because of model overfitting, which then lacks the ability to generalize to new data samples; due to noise being present in the target data samples, etc. Classifiers failing to indicate when they are likely mistaken can limit their efficacy, especially in mission-critical applications. For example, a model trained to predict a medical diagnosis may consistently output predictions with high confidence scores, while failing to flag difficult examples for human intervention. The resulting erroneous diagnoses could pose undue risk to human lives, and may impede the adoption of machine learning technologies in such applications medicine.

Accordingly, in some embodiments, the present disclosure provides for a confidence score validation process, wherein at least some inference instances are iterated over multiple transformations of the target data sample, to generate a corresponding number of inference predictions, each with an associated assigned confidence score. The confidence scores are then aggregated and/or combined to generate a consensus confidence score for the target data sample classification, thereby increasing the overall certainty of the classification and reducing the potential for errors.

In some embodiments, each of the iterated classified target data sample transformations may then be automatically assigned the final consensus classification and confidence score. In some embodiments, each of the iterated classified target data sample transformations, as annotated with class labels based on the consensus classification, may then be used as additional training data, to re-train the machine learning model.

A potential advantage of the present disclosure is, therefore, in that provides for a robust automated classification enhancement and validation process, based on simple image manipulation techniques, which can be performed in real time, seamlessly, and with low latency and resource overhead. The present process increases prediction accuracy, helps to identify challenging data samples which may result in erroneous ow low-confidence prediction, and provides for re-training of the predictive model to improve generalization and reduce possible overfitting and similar errors.

The present disclosure discusses extensively applications of the present technique with respect to data instances that are images and/or presented as image data. However, the present disclosure may be equally effective when applied to other types or categories of data, including, but not limited to, time-series data, attribute-based data, vectors, graph data, video data, tabular data, biological data, chemical data, population data, financial data, etc.

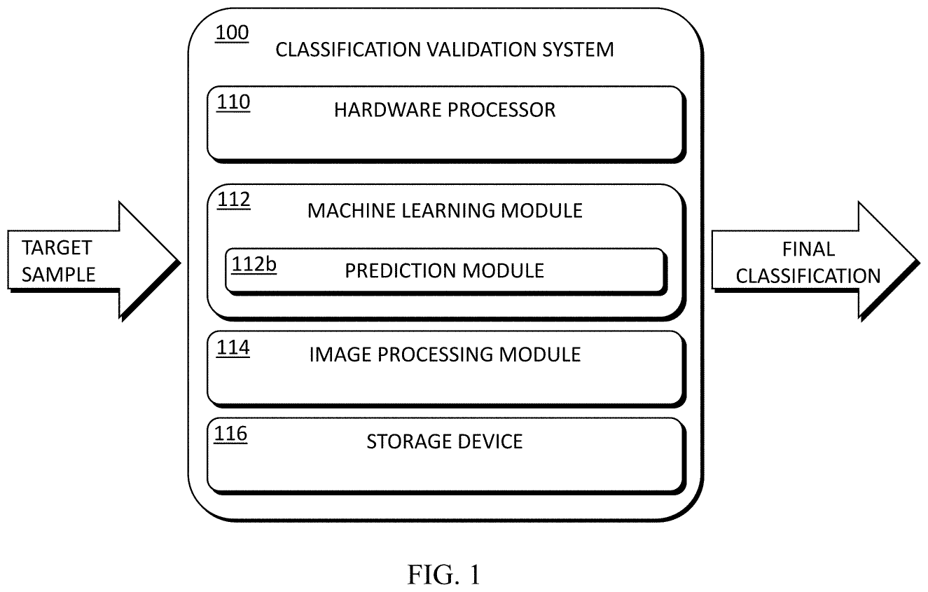

FIG. 1 illustrates an exemplary system 100 for automated real-time confidence score validation, in accordance with some embodiments of the present invention. System 100 as described herein is only an exemplary embodiment of the present invention, and in practice may have more or fewer components than shown, may combine two or more of the components, or may have a different configuration or arrangement of the components. The various components of system 100 may be implemented in hardware, software, or a combination of both hardware and software. In various embodiments, system 100 may comprise a dedicated hardware device, or may form an addition to or extension of an existing device.

In some embodiments, system 100 may comprise a hardware processor 110 and memory storage device 116, comprising a random-access memory (RAM) and one or more non-transitory computer-readable storage device(s). In some embodiments, system 100 may store in a non-volatile memory thereof, such as storage device 116, software instructions or components configured to operate a processing unit (also ‘hardware processor,’ ‘CPU,’ or simply ‘processor’), such as hardware processor 110. The program instructions may include one or more software modules, such as a machine learning module 112, which may comprise a prediction module 112bb, and image processing module 114. In some embodiments, the software components may include an operating system, including various software components and/or drivers for controlling and managing general system tasks (e.g., memory management, storage device control, power management, etc.) and facilitating communication between various hardware and software components.

In some embodiments machine learning module 112 and/or prediction module 112bb may be configured to apply any one or more machine learning algorithms and techniques, using any suitable neural network and/or similar architecture. In some embodiments, the instructions of machine learning module 112 may cause system 100 to train and implement a machine learning model using one or more training datasets, and to output a trained machine learning model, e.g., prediction module 112bb. In some embodiments, machine learning module 112 may train, implement, and inference any suitable machine learning model, such as prediction module 112bb, using various model architectures.

The term ‘techniques’ may refer to systems, methods, computer-readable instructions, modules, algorithms, hardware logic and/or operations as permitted by the context described throughout this document.

As noted above, a machine learning model is any of several methods and/or algorithms which are configured to perform a specific informational task (such as classification) using a limited number of examples of data of a given form, and are then capable of exercising this same task on unknown data of the same type and form. The terms ‘machine learning model’ and ‘machine learning classifier’ or simply ‘classifier’ may be used interchangeably to refer to any type of machine learning model which is capable of performing a discriminative and/or generative task and producing an output, e.g., a classification, a prediction, or generation of new data, based on input. A machine learning model may be implemented using various model architectures and training algorithms, e.g., deep convolutional neural networks (CNNs), fully convolutional neural networks (FCNs), or recurrent neural networks (RNNs).

In some embodiments, the instructions of prediction module 112bb may cause system 100 to inference prediction module 112bb on one or more provided data samples, and to output a prediction associated with each inference instance, wherein the prediction may be associated with a confidence score or value. The terms ‘detection,’ ‘classification’ and ‘prediction’ may be used interchangeably for reasons of simplicity, and are intended to refer to any type of discriminative output of a machine learning model. This output may be in the form of a class and a score which indicates the certainty that the input belongs to that class. Various types of machine learning models may be configured to handle different types of input and produce respective types of output; all such types are intended to be covered by present embodiments.

In some embodiments, the image processing module 114 may be configured to receive image data and apply any one or more image processing and/or computer vision algorithms or techniques. In some embodiments, image processing module 114 may be configured to perform one or more of object detection, object recognition, object tracking, and/or image segmentation based on one or more image processing techniques. In some embodiments, image processing module 114 may be configured to perform one or more desired image modifications, transformations, filtering, enhancing, and/or any other manipulations with respect to received image data. As used herein, terms ‘image,’ ‘image data,’ and/or ‘digital image’ refer to any digital data capable of producing a visual representation, including digital images and digital video. Such data may comprise digital files in any suitable format, e.g., JPG, TIFF, BMP, PNG, RAW, or PDF files. Video data may refer to a digital sequence of images comprising comprise digital files in any suitable format, e.g., FLV, GIF, MOV, QT, AVI, WMV, MP4, MPG, MPEG, or M4V. Although much of the disclosure herein focuses on digital images, the present disclosure may be equally applied with regard to any type of digital visual media. For instance, in addition to digital images, the present disclosure may also apply with respect to multiple images/frames in a digital video. Depending on the embodiment, the image processing module 114 can also transmit and/or route image data through various processing functions, or to an output circuit that sends received and/or processed image data for further processing by one or more other modules of system 100; for presentation, e.g., on a display; to a recording system; across a network; or to any other logical destination. The image processing module 114 may apply any image processing algorithms alone or in combination. Image processing module 114 may also facilitate logging or recording operations with respect to any image data scan.

System 100 as described herein is only an exemplary embodiment of the present invention, and in practice may be implemented in hardware only, software only, or a combination of both hardware and software. System 100 may have more or fewer components and modules than shown, may combine two or more of the components, or may have a different configuration or arrangement of the components. System 100 may include any additional component enabling it to function as an operable computer system, such as a motherboard, data busses, power supply, a network interface card, a display, an input device (e.g., keyboard, pointing device, touch-sensitive display), etc. (not shown). Moreover, components of system 100 may be co-located or distributed, or the system may be configured to run as one or more cloud computing ‘instances,’ ‘containers,’ ‘virtual machines,’ or other types of encapsulated software applications, as known in the art. As one example, system 100 may in fact be realized by two or more separate but similar systems. These two or more systems may cooperate, such as by transmitting data from one system to the other (over a local area network, a wide area network, etc.), so as to use the output of one module as input to the other module.

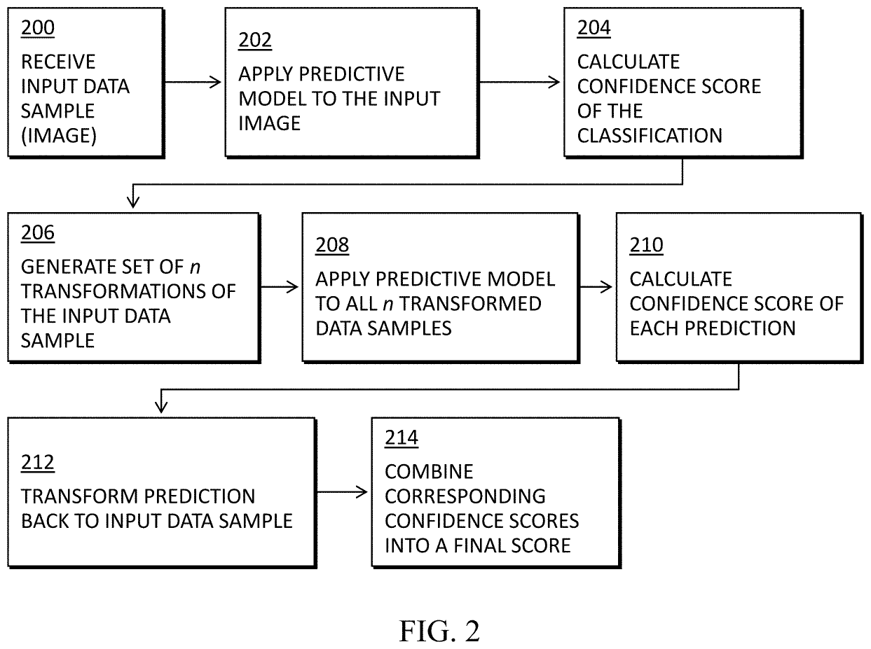

The instructions of machine learning module 112, prediction module 112bb, and/or image processing module 114 are now discussed with reference to the flowchart of FIG. 2, which illustrates the functional steps in a method for automated real-time confidence score validation, in accordance with some embodiments of the present invention.

In some embodiments, in step 200, system 100 may receive, as input, a data sample in the form of image data, e.g., representing one or more digital images and/or portions thereof.

In some embodiments, in step 202, system 100 may be configured to apply a trained machine learning model, e.g., prediction module 112bb, to the received image data, to generate a corresponding inference output based on the training scheme of the machine learning model. For example, prediction module 112bb may be applied to perform any one or more of the following with respect to the received image data: image classification, object detection, object recognition, a segmentation task, and/or any other similar operation.

By way of example only, the present disclosure will be described herein mainly with reference to the tasks of image classification and object detection in images. However, it will be appreciated by any artisan skilled in the art that the present process may be equally successfully applied in the context of any machine learning-based classification and/or prediction task which involves probabilistic classification, such as object recognition, identification, pose estimation, optical character recognition, facial recognition, document classification, sentiment analysis, pixel classification, object segmentation, and the like.

In some embodiments, prediction module 112b may be configured to classify an entire image, and/or classify one or more candidate objects of interest within the image, and represent the identified objects of interest in the form of, e.g., bounding boxes, masking, edge detection, or other form of recognizing the location of candidate objects in an image. In some embodiments, object detection and/or classification may be configured to detect and classify specific types of objects or portions thereof. In some embodiments, object detection and/or classification may be configured to detect more than one objects in an image, detect objects in the background, etc. In some embodiments, prediction module 112b may further be configured to evaluate each identified object of interest and determine a classification (e.g., a type, a class, a group, a category, etc.) of the candidate object. In some examples, the classification of the object can be based on a pre-determined fixed number of object classes. For example, the prediction module 112b can evaluate the object and determine that the object is one of, e.g., 2, 3, 4, 5, 10, 15, 20, or more object classes, and/or any number in between.

In various examples, in step 204, prediction module 112b calculates a confidence score associated with the inference output generated in step 202.

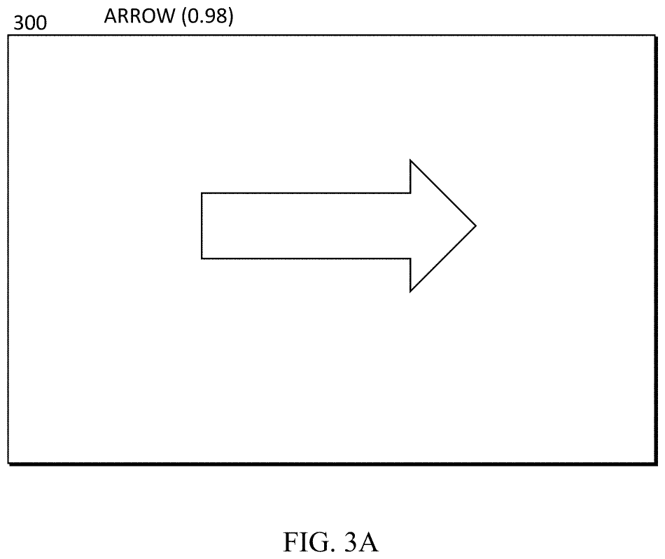

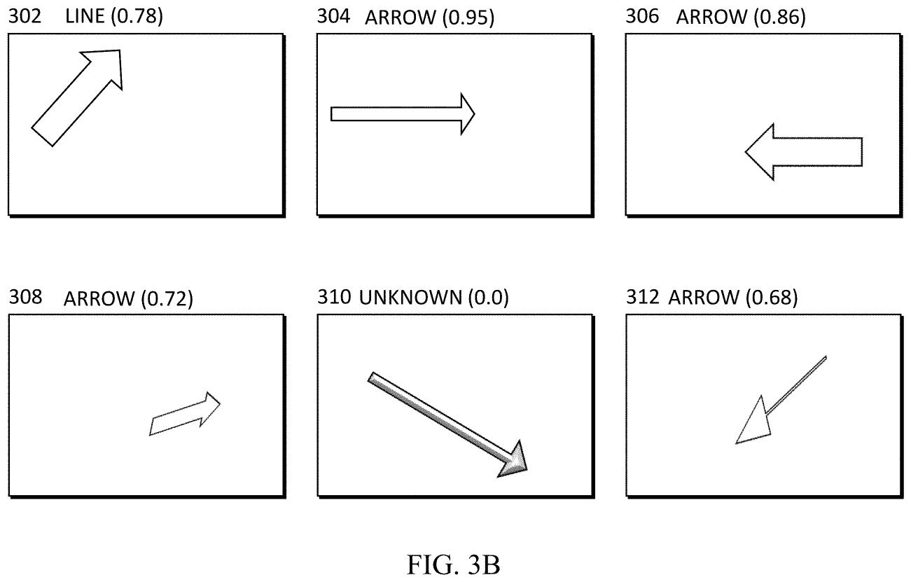

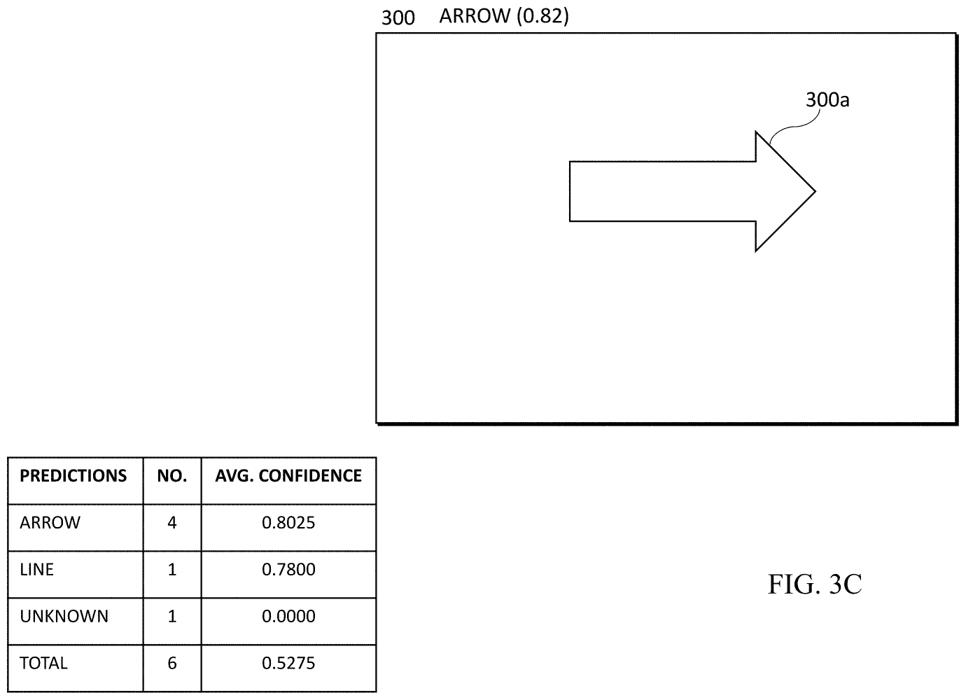

FIGS. 3A-3C schematically illustrate a process for automated real-time confidence score validation in image classification. FIG. 3A shows an input image 300 depicting an arrow pointing to the right. In some embodiments, prediction module 112b may be configured to classify image 300, to predict whether image 300 represents an “arrow” or a “line,” i.e., whether an input data sample (image 300) is more likely to be a member of the class “arrows” or the class “lines.” In some embodiments, prediction module 112b may be configured to calculate a probability or likelihood that image 300 indeed belongs to the class to which is was assigned.

For example, in FIG. 3A, prediction module 112b calculates a confidence score of 0.98 associated with the classification of image 300 as representing an “arrow.” This means that prediction module 112b predicts that image 300 is a member the class “arrows” with a 98% level of confidence.

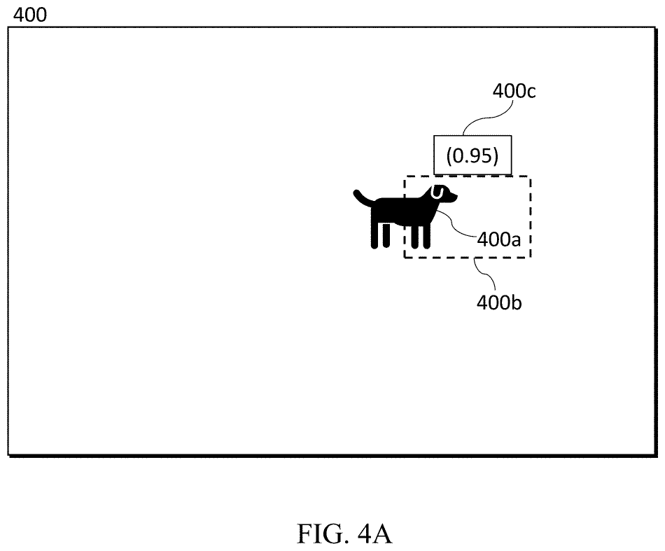

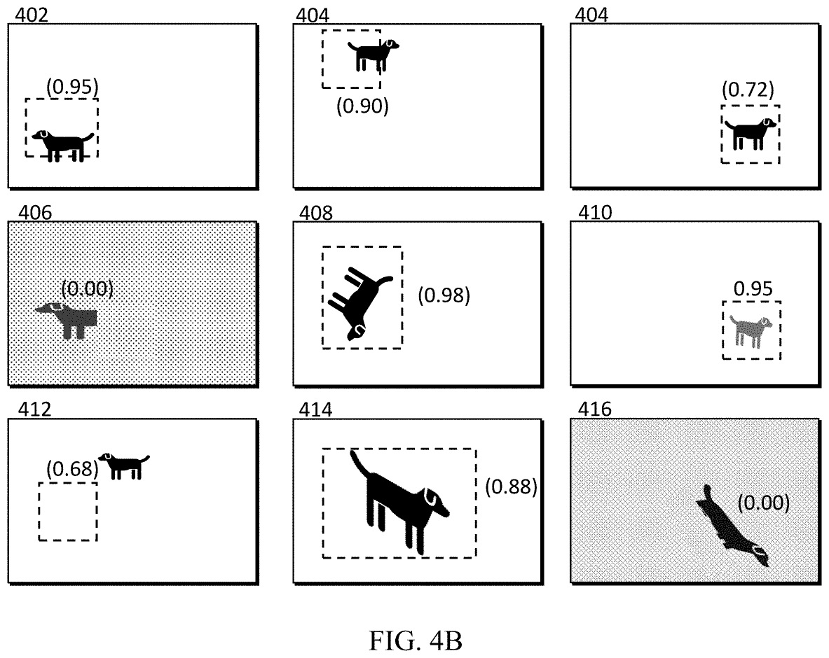

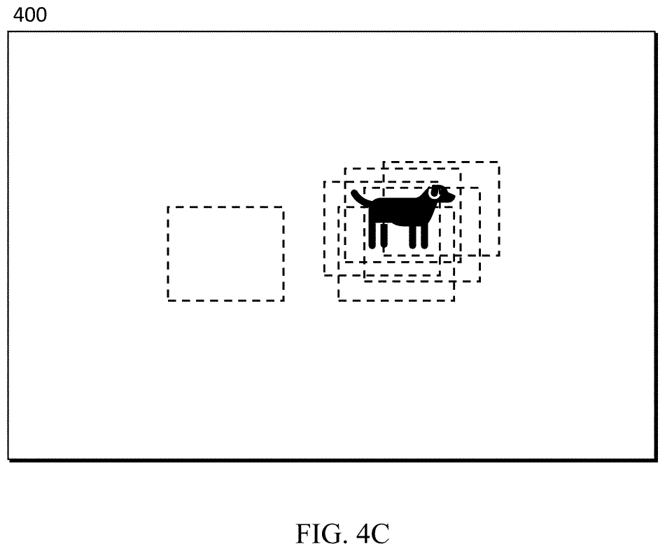

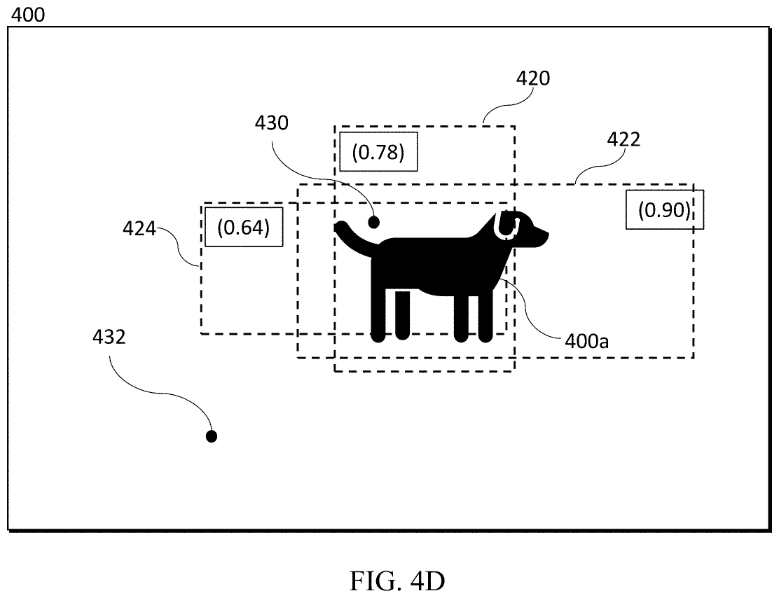

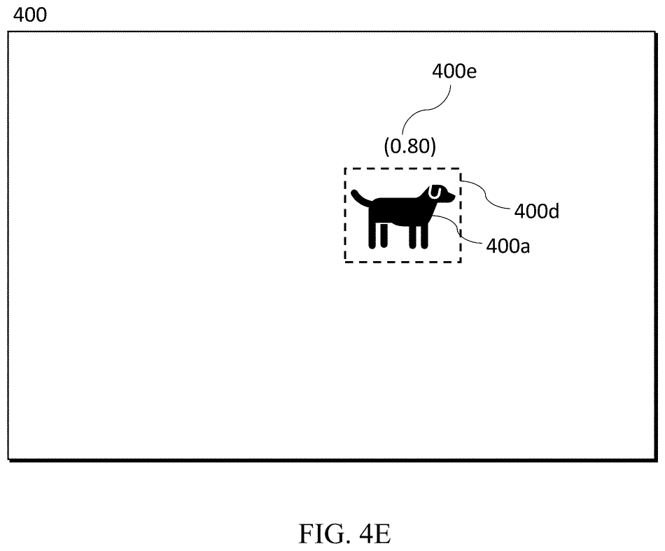

FIGS. 4A-4E schematically illustrate a process for automated real-time confidence score validation in object detection. FIG. 4A shows an input image 400 depicting a dog 400a. In this example, prediction module 112b may be configured to detect dog 400a and enclose it in, e.g., a bounding region, e.g., bounding box 400b. In some embodiments, the results of object detection may be represented as a bounding region within the image, e.g., a rectangular bounding box. While this type of object detection result is shown and discussed extensively in the examples below, the bounding regions can be other shapes, such as circles, other types of polygons, etc. Similarly, the annotation data may include coordinates of the bounding regions, texts, or identifiers for the classification labels of objects, as well as confidence measures of the contributor.

For example, in FIG. 4A, the results of the classification operation are not successful in that bounding region 400b does not accurately enclose the entirety of dog 400a. Nevertheless, confidence score 400c indicates a high level of confidence in the detection and classification, e.g., confidence score 400c (0.95) in FIG. 4A.

In such examples, the confidence score may be based on the degree of certainty that the image or the object within it is of the category to which it is assigned. For example, in FIG. 4A, the classifier may determine that a candidate object of interest is a dog. Because the shape of a dog is so distinctive, the object classifier module may determine that it is 95% certain that the object of interest is a dog, thus resulting in a confidence score of 0.95. In another example, the candidate object of interest may be blurry or less distinct. Therefore, the object classifier module may have a lower confidence in the object class, and may assign a confidence score of, for example, 0.8. In other examples, lower confidence scores may be the result of, e.g.:
Viewpoint variation: A single instance of an object can be oriented in many ways with respect to the camera.
Scale variation: Visual classes often exhibit variation in their size (size in the real world, not only in terms of their extent in the image).
Deformation: Many objects of interest are not rigid bodies and can be deformed in extreme ways.
Occlusion: The objects of interest can be occluded. Sometimes only a small portion of an object (as little as few pixels) could be visible.
Illumination conditions: The effects of illumination are drastic on the pixel level.
Background clutter: The objects of interest may blend into their environment, making them hard to identify.
Intra-class variation: The classes of interest can often be relatively broad, such as chair. There are many different types of these objects, each with their own appearance.

In some embodiments, in step 206, a confidence validation process may begin with respect to the confidence score produced in step 204.

Although the confidence validation process shown and discussed extensively in the examples below is implemented for an image as a whole and/or for a single object in within an input image, depending on the implementation, the same or similar process may with respect to other classification tasks, e.g., object detection of more than one object in the input image, consecutively or simultaneously.

In some embodiments, image processing module 114 may generate a plurality of transformations of the received data samples in step 200, e.g., input images 300 and/or 400. In some embodiments, the plurality of transformation generates a set of various representations of the input image.

As depicted in FIGS. 3B and 4B, input images 300 and 400 may be transformed into one or more of image set 302-312 and 402-416 respectively, using any number of image transformations. In some embodiments, such image transformation may comprise:
Image enhancements (e.g., contrast enhancements, contrast stretching, gray level thresholding);
color changes;
filtering,
Gaussian blur;
sharpening;
gamma correction;
shearing;
identity function;
padding;
reflection;
warping;
scaling;
rotations;
translations;
flipping;
affine transformations; and/or
projections.

In some embodiments, additional and/or other image modifications, enhancements and/or transformations may be applied.

In some embodiments, at the conclusion of step 206, the present disclosure provides for a set of n images, e.g., images 302-312 in FIG. 3B, and images 402-416 in FIG. 4B, representing a variety of enhancements, modification, and/or transformations of the input image(s).

In some embodiments, in step 208, prediction module 112b may be applied to each transformed image, to generate a corresponding data set comprising a prediction output with respect to each of the n image transformation in the set generated in step 206.

For example, as can be seen in FIG. 3B, prediction module 112b is applied to each of images 302-312 to perform output an inference (e.g., perform a classification task) with respect to each image 302-312. In the example of FIG. 3B, each inference of prediction module 112b on images 302-312 may result in a classification of the respective image as into one of two classes: “arrows” and “lines.”

In another example seen in FIG. 4B, prediction module 112b is applied to each of images 402-416 to output a prediction, e.g., perform object detection and classification of an object in the images, e.g., dog 400a shown in input image 400 in FIG. 4A. In some embodiments, each inference of prediction module 112b may result in, e.g., a bounding box, a binary mask, and/or another form of recognizing the location of a candidate object in the image. In some examples, the various inferences over the transformed images 402-416 may provide a set of proposed bounding regions having, e.g., different sizes and/or locations within the respective images. In some embodiments, at least some of the inferences of prediction module 112b may result in no object detection (e.g., in images 406 and 416).

In some embodiments, in step 210, inferencing prediction module 112b on the transformed images may provide for calculating a confidence score for each inference, as can be seen in FIGS. 3B and 4B. For example, the predictions output by prediction module 112b may include a confidence score represented in parenthesis with respect to each image 302-312 in FIG. 3B. Similarly, the predictions output by prediction module 112b may include a confidence score represented in parenthesis with respect to each image 402-416 in FIG. 4B.

In some embodiments, in step 212, the prediction results may be aggregated and assigned to the original input image.

For example, in FIG. 3C, image 300 receives 6 different prediction (classification) results, each having its associated confidence score. Accordingly, the combined or aggregated value of all 6 scores may be calculated, e.g., based on a summation, a weighted sum, and/or any other suitable calculation. In the case of FIG. 3C, a linear summation of the confidence scores of all 6 predictions results in a consensus confidence score of 0.5275.

For example, in FIG. 4C, the object detection results (e.g., proposed bounding regions) in each transformed image 402-416 are transformed back to input image 400. For example, in some embodiments, each bounding region detected in images 402-416 is transformed back to corresponding coordinates in the input image.

As shown in the in FIG. 4C, the various detection results may reflect disagreement as to the location, coordinates, and or size of a bounding region of the detected object among the different inferences. In some embodiments, the bounding regions can overlap fully or partially, and can be fully or only partially aligned. In some embodiments, the set of proposed detections generate, e.g., a search space of detections and class probabilities independently for each detection.

Accordingly, in step 214, the present disclosure provides for collapsing the set of classification aggregated in step 212 into a single combined classification having a confidence score.

As noted above, the confidence score of a machine learning-based detection and classification specifies the probability of the classification, and is computed by the machine learning model to indicate how confident the process is in making the particular classification.

In some embodiments, multiple methods and/or algorithms may be used to combine the multiple classifications and confidence scores into a combined classification and confidence score. In some embodiments, the computation takes into account weightings, e.g., based on the relative number of classification in each class, or a number of bounding regions in which a pixel is included.

In some examples, an algorithm such as a non-maximum suppression (NMS) algorithm. For example, in the object detection task, because the actual goal is to generate a single detection for the object of interest 400a, the NMS algorithm may assume that highly overlapping detections belong to the same object of interest and collapse them into one detection. The algorithm thus accepts the highest scoring detection, while rejecting all detections that overlap more than a specified threshold value. This process repeats with the remaining detections, i.e., accepting local maxima and discarding their neighbors.

In some embodiments, the prediction (e.g., detection and/or classification) may be pixel-level, e.g., a pixel in each of the images 400-416 is associated with a value that depends on whether the pixel is within any bounding region detected for the object of interest. In some embodiments, pixels within a bounding region are associated with the same value (e.g., confidence value) assigned to the bounding region.

In some embodiments, a bounding region combining process may be based on computing a combined value for each pixel. For example, as can be seen in FIG. 4C, when the multiple bounding regions overlap, a pixel included within the area of multiple bounding regions may receive a value reflecting multiple confidence score associated with the multiple bounding regions, e.g., a weighted sum of all of these confidence scores.

For example, with reference to FIG. 4D, object of interest 400a is bounded within three partially-overlapping bounding regions 420, 422, 424, having confidence score of 0.78, 0.64, and 0.90, respectively. In some embodiments, each pixel in image 400 is thus given a pixel value associated with its corresponding bounding regions. For example, pixel 430, which is inside all three regions 420, 422, 424, has a pixel value that is computed as a sum (e.g., a weighted sum) of confidence scores 0.78, 0.64, and 0.90. Pixel 432, which is not inside any of the bounding regions, has a pixel value of 0.

Accordingly, in some embodiments, a further operation may determine a combined bounding region for the object of interest 400a, based, at least in part, on the combined confidence score assigned to each pixel in image 400 based, e.g., on a threshold value or the like.

FIG. 4E shows the final combined bounding region 400d and confidence score 400e for object of interest 400a. As can be seen, the combined final bounding region 400d correctly encloses object 400a, while the combined confidence score 400e is lower than the initial score 400c of 0.95 (FIG. 4A).

The combined score thus reflects reduced certainty in the prediction, but greater accuracy. It may be further utilized to identify images that pose a challenge to the detection model, and thus assist in crafting a suitable re-training dataset for refining the detection model. Accordingly, in some embodiments, the final combined bounding region and/or confidence score may be used to automatically annotate one or more of the transformed images (302-312 in FIG. 3B, and 402-416 in FIG. 4B). For example, the final combined bounding region and/or confidence score may be used to automatically annotate images 310 in FIG. 3B, and 406 and 416 in FIG. 4B, in which the model did not obtain a classification at all. In other examples, the final combined bounding region and/or confidence score may be used to automatically annotate images where the detection was inaccurate—e.g., images 312 in FIG. 3B, and 404 and/or 412 in FIG. 4B.

The present invention may be a computer system, a computer-implemented method, and/or a computer program product. The computer program product may include a computer readable storage medium (or media) having computer readable program instructions thereon for causing a hardware processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire. Rather, the computer readable storage medium is a non-transient (i.e., not-volatile) medium.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, a field-programmable gate array (FPGA), or a programmable logic array (PLA) may execute the computer readable program instructions by utilizing state information of the computer readable program instructions to personalize the electronic circuitry, in order to perform aspects of the present invention. In some embodiments, electronic circuitry including, for example, an application-specific integrated circuit (ASIC), may be incorporate the computer readable program instructions already at time of fabrication, such that the ASIC is configured to execute these instructions without programming.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a hardware processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

In the description and claims, each of the terms “substantially,” “essentially,” and forms thereof, when describing a numerical value, means up to a 20% deviation (namely, ±20%) from that value. Similarly, when such a term describes a numerical range, it means up to a 20% broader range—10% over that explicit range and 10% below it).

In the description, any given numerical range should be considered to have specifically disclosed all the possible subranges as well as individual numerical values within that range, such that each such subrange and individual numerical value constitutes an embodiment of the invention. This applies regardless of the breadth of the range. For example, description of a range of integers from 1 to 6 should be considered to have specifically disclosed subranges such as from 1 to 3, from 1 to 4, from 1 to 5, from 2 to 4, from 2 to 6, from 3 to 6, etc., as well as individual numbers within that range, for example, 1, 4, and 6. Similarly, description of a range of fractions, for example from 0.6 to 1.1, should be considered to have specifically disclosed subranges such as from 0.6 to 0.9, from 0.7 to 1.1, from 0.9 to 1, from 0.8 to 0.9, from 0.6 to 1.1, from 1 to 1.1 etc., as well as individual numbers within that range, for example 0.7, 1, and 1.1.

The descriptions of the various embodiments of the present invention have been presented for purposes of illustration, but are not intended to be exhaustive or limited to the explicit descriptions. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

In the description and claims of the application, each of the words “comprise,” “include,” and “have,” as well as forms thereof, are not necessarily limited to members in a list with which the words may be associated.

Where there are inconsistencies between the description and any document incorporated by reference or otherwise relied upon, it is intended that the present description controls.

What is claimed is:

1. A system comprising:
at least one hardware processor; and
a non-transitory computer-readable storage medium having stored thereon program instructions, the program instructions executable by the at least one hardware processor to:
receive, as input, an image for classification by a trained machine learning model,
generate a data set comprising a plurality of transformations of said image,
apply, to each of said transformations in said data set, said trained machine learning model, to obtain a classification with respect to said transformation, wherein said classification has an associated confidence score,
compute:
(i) a consensus classification based on all of said obtained classifications with respect to each of said transformations, and
(ii) a consensus confidence score corresponding to said consensus classification, based on all of said associated confidence scores, and
output said consensus classification and said corresponding consensus confidence score, as a classification result with respect to said image.

2. The system of claim 1, wherein said program instructions are further executable to assign (i) said consensus classification and (ii) said corresponding consensus confidence score, as annotations to at least one of said transformations in said data set, to obtain at least one annotated transformation.

3. The system of claim 2, wherein said program instructions are further executable to use said at least one annotated transformation to re-train said trained machine learning model.

4. The system of claim 1, wherein said classification comprises performing, with respect to each of said transformations, object detection with respect to an object of interest, and wherein said object detection is represented as a bounding region enclosing said object of interest.

5. The system of claim 4, wherein said computing of said consensus classification comprises (i) translating each of said bounding regions to corresponding coordinates in said image, and (ii) computing a consensus bounding region from all of said translated bounding regions.

6. The system of claim 5, wherein said program instructions are further executable to assign (i) said consensus bounding region and (ii) said consensus confidence score, as annotations to at least one of said transformations in said data set, to obtain at least one annotated transformation.

7. The system of claim 1, wherein said computing of said consensus classification is based, at least in part, on a weighted sum calculation of all of said obtained classifications, and wherein said weights are based on said confidence scores associated with each of said obtained classifications.

8. The system of claim 1, wherein said transformations comprise one or more of: image enhancements, image contrast enhancements, image contrast stretching, image gray level thresholding, image color changes, image filtering, image Gaussian blur, image sharpening, image gamma correction, image shearing, image padding, image reflection, image warping, image scaling, image rotations, image translations, image flipping, affine image transformations, geometric image transformations, and image projections.

9. A method comprising:
receiving, as input, an image for classification by a trained machine learning model,
generate a data set comprising a plurality of transformations of said image;
applying, to each of said transformations in said data set, said trained machine learning model, to obtain a classification with respect to said transformation, wherein said classification has an associated confidence score;
computing:
(i) a consensus classification based on all of said obtained classifications with respect to each of said transformations, and
(ii) a consensus confidence score corresponding to said consensus classification, based on all of said associated confidence scores; and
outputting said consensus classification and said corresponding consensus confidence score, as a classification result with respect to said image.

10. The method of claim 9, further comprising assigning (i) said consensus classification and (ii) said corresponding consensus confidence score, as annotations to at least one of said transformations in said data set, to obtain at least one annotated transformation.

11. The method of claim 10, further comprising using said at least one annotated transformation to re-train said trained machine learning model.

12. The method of claim 9, wherein said classification comprises performing, with respect to each of said transformations, object detection with respect to an object of interest, and wherein said object detection is represented as a bounding region enclosing said object of interest.

13. The method of claim 12, wherein said computing of said consensus classification comprises (i) translating each of said bounding regions to corresponding coordinates in said image, and (ii) computing a consensus bounding region from all of said translated bounding regions.

14. The method of claim 13, further comprising assigning (i) said consensus bounding region and (ii) said consensus confidence score, as annotations to at least one of said transformations in said data set, to obtain at least one annotated transformation.

15. The method of claim 9, wherein said computing of said consensus classification is based, at least in part, on a weighted sum calculation of all of said obtained classifications, and wherein said weights are based on said confidence scores associated with each of said obtained classifications.

16. The method of claim 9, wherein said transformations comprise one or more of: image enhancements, image contrast enhancements, image contrast stretching, image gray level thresholding, image color changes, image filtering, image Gaussian blur, image sharpening, image gamma correction, image shearing, image padding, image reflection, image warping, image scaling, image rotations, image translations, image flipping, affine image transformations, geometric image transformations, and image projections.

17. A computer program product comprising a non-transitory computer-readable storage medium having program instructions embodied therewith, the program instructions executable by at least one hardware processor to:
receive, as input, an image for classification by a trained machine learning model;
generate a data set comprising a plurality of transformations of said image;
apply, to each of said transformations in said data set, said trained machine learning model, to obtain a classification with respect to said transformation, wherein said classification has an associated confidence score;
compute:
(i) a consensus classification based on all of said obtained classifications with respect to each of said transformations, and
(ii) a consensus confidence score corresponding to said consensus classification, based on all of said associated confidence scores; and
output said consensus classification and said corresponding consensus confidence score, as a classification result with respect to said image.

18. The computer program product of claim 17, wherein said program instructions are further executable to assign (i) said consensus classification and (ii) said corresponding consensus confidence score, as annotations to at least one of said transformations in said data set, to obtain at least one annotated transformation, and wherein said program instructions are further executable to use said at least one annotated transformation to re-train said trained machine learning model.

19. The computer program product of claim 17, wherein said classification comprises performing, with respect to each of said transformations, object detection with respect to an object of interest, and wherein said object detection is represented as a bounding region enclosing said object of interest.

20. The computer program product of claim 17, wherein said transformations comprise one or more of: image enhancements, image contrast enhancements, image contrast stretching, image gray level thresholding, image color changes, image filtering, image Gaussian blur, image sharpening, image gamma correction, image shearing, image padding, image reflection, image warping, image scaling, image rotations, image translations, image flipping, affine image transformations, geometric image transformations, and image projections.
